(19) United States
(12) Patent Application Publication
(10) Pub. No.: US 2016/0129416 A1
(43) Pub. Date: May 12, 2016

(54) MICROARRAY MINI-MIXER

(71) Applicant: Grace Bio-Labs, Inc., Bend, OR (US)

(72) Inventors: Florian Bell, Bend, OR (US); Donna Barton, Bend, OR (US); Jacob Burrel Wells, Bend, OR (US)

(21) Appl. No.: 14/931,330

(22) Filed: Nov. 3, 2015

Related U.S. Application Data
(60) Provisional application No. 62/076,253, filed on Nov. 6, 2014.

(51) Int. Cl. B01J 19/00

(52) U.S. Cl. CPC B01J 19/0046; B01J 2219/00331; B01J 2219/00689; B01J 2219/00599; B01J 2219/00484

(57) ABSTRACT

Systems, methods, and apparatuses for microarray mixing are provided. In one embodiment, a system comprises a microarray having one or more vibration motors coupled thereto, and psuedo-random voltage signals are provided to the vibration motors to agitate the microarray. In this way, the size of a microarray mixer can be reduced while avoiding standing wave artifacts in the microarray background.

### CROSS REFERENCE TO RELATED APPLICATION

The present application claims priority to U.S. Provisional Patent Application No. 62/076,253, entitled “MICROARRAY MINI-MIXER,” filed on Nov. 6, 2014, the entire contents of which are hereby incorporated by reference for all purposes.

### BACKGROUND

In recent years, microarray immunoassays have become increasingly popular alternatives to container-based assays for proteomic research. Microarrays offer the advantages of much higher density analyses and the use of much smaller reaction volumes compared to conventional ELISA assays. In one form of the microarray, material containing analytes to be detected is printed in a rectangular array onto the microarray surface. Typically, bio-molecular reactants such as antibodies in aqueous solutions react with one or more analytes which are subsequently detected through the use of fluorescent labels attached to the analyzing reactant. To increase specificity of detection, both primary and secondary antibodies are sequentially introduced. Microarrays often provide a plurality of reaction sites on a single reaction surface. Small reaction volumes are important when the amount of biological sample or its analyte is limited.

In microarray assays, thorough mixing of the aqueous solution is imperative for several reasons. First, to achieve assays that proceed to their chemical endpoint, microscopic areas of the analyte (reactant) may be continuously exposed to its corresponding reactant (analyte). Second, when the reaction is complete, the analyte (reactant) may be removed from the vessel and the reaction chamber may be rinsed to remove excess reactant (analyte). This latter requirement is important to reduce spurious background signals that can reduce the signal-to-noise (SNR) of the microarray detection. When microarrays are printed on porous nitrocellulose as the reaction surface, efficient mixing becomes even more important, to better drive the reactants into the pores of the surface. After reaction is complete, the reactants may be rinsed thoroughly from the surface. Because reactants are often large molecules such as antibodies, they require intense, localized vibration energy to promote them from the surface pores. Specialized instrumentation is required to provide the energies of this magnitude.

In the past, mixing of the aqueous solution has been obtained through the use of various mechanical means. Commercially-available laboratory mixers are available in a variety of forms, including orbital-surface shakers, oscillatory-surface shakers, low-speed “belly dancer” oscillators, and programmable vibration instruments designed specifically for particular labware geometries such as microtiter plates. Mixing and distribution of the analyte sample over the reactant surface is accomplished by: (a) tilting the reactant surface such that the analyte sample flows over the reactant surface under the force of gravity and/or (b) horizontal movements that promote wave movement (agitation) of the aqueous solution, and/or (c) semi-vibrational motion induced by oscillations along a single axis or about an angular axis, and/or (d) mechanical motions that produce vortices within the fluid. A fundamental limitation of these methods is that they are primarily designed to agitate fluids confined in large-area reaction chambers that have dimensionality of greater than one centimeter. Efficient wave mixing can occur as long as the dimensionality of the vessel is large compared to the depth of the reaction chamber. In the shallow-wave limit, the maximum speed of water waves is proportional to the square-root of the depth of the vessel. Thus, there is a practical upper limit on the speed of wave mixing in a small container when the force of gravity is the primary driver. In the case of microarrays, the reaction chamber size is often small (less than 10 mm). Under these circumstances, surface tension of water impedes the horizontal (wave) motion, reducing the efficiency of mixing and possibly promoting standing waves that can trap reactants, causing wispy background artifacts in the microarray image. Similarly, oscillatory mixers and vortex mixers rely on periodic motion to introduce turbulence in the solution. Turbulence is limited in aqueous solutions when the vessel is small.

These problems as well as others recognized by the inventors herein and not admitted to be generally known, are exacerbated by the geometry of the vessel, as rectangular geometries will lead to linear “dead zones” in the solution and circular geometries will lead to circular standing wave dead zones where poor mixing occurs. Mixers that rely on periodic motion are more likely to produce standing-wave dead zones in the vessel, regardless of whether the geometry is rectangular or cylindrical.

Despite these limitations, several commercial vendors provide examples of mixing devices common in laboratory practice. An example is the Bioshake IQ, which provides a fixed, 2 mm orbital motion whose frequency is adjustable between 200 and 3000 rpm. Other commercial instruments provide orbital, linear oscillatory, and angular oscillatory motion to effect wave motion in the solution. Additional art contains several inventions intended to overcome the limitations described above. U.S. Pat. No. 7,238,521 and U.S. Pat. No. 6,913,931 B2 describe devices for tilting the reaction surface to permit mixing. U.S. Pat. No. 7,578,612 B2 describes a device that utilizes three-phase tilting to provide wave mixing in microarray configurations. U.S. 7,238,521 B2 describes a device incorporating sharp edges within the reaction vessel intended to break up bubbles. U.S. 2010/0232255 A1 describes a microfluidic device that continually mixes the solutions through forced flow. As recognized by the inventors herein, these devices have limited practical application when used with small vessels, especially in robotics where physical space to incorporate the mixers may be limited.

To overcome the problems outlined above, systems, methods, and apparatuses for microarray mixing are provided herein. In one embodiment, a system comprises a microarray having one or more vibration motors coupled thereto. Psuedo-random voltage signals are provided to the vibration motors to agitate the microarray. In this way, the size of a microarray mixer can be reduced while avoiding standing wave artifacts in the microarray background.

### BRIEF DESCRIPTION OF THE FIGURES

FIG. 1 shows a pictorial view of an agitation device according to an embodiment of the invention;

FIG. 2 shows a block diagram illustrating an example motor configuration included in the agitation device of FIG. 1;

FIG. 3 shows a set of graphs illustrating example voltage control of a plurality of vibration motors;

FIG. 4 shows a pictorial view of an example coin-shaped motor; and

FIG. 5 shows an exploded view of the example coin-shaped motor of FIG. 4.

### DETAILED DESCRIPTION

This present disclosure describes various examples of an agitation device suitable for efficient mixing of reagents in a microarray reaction vessel or microfluidic device. As an alternative to conventional laboratory mixers, embodiments of the present device may utilize miniature vibration motors coupled to a reaction vessel mount. Vibration from the motors efficiently couples to the reaction chamber, providing a pseudo-random mechanical motion on a small scale. Through the use of a microcontroller in electrical communication with one or more of the motors, the device can be programmed to agitate with a variety of mechanical motions. Due to its miniature size, the device is easily adaptable to both manual and robotic applications where microarrays are processed.

To provide efficient mixing of reagents and concomitant exposure of the reaction surfaces in small containers and miniature closed containers, the inventors have recognized various different concepts may be used. There are several factors, again as recognized by the inventors, that may be taken into consideration in this regard: (1) for small containers, wave action driven by the force of gravity is inefficient, (2) agitative motion may be produced with higher frequency and smaller amplitude to overcome the effects of surface tension, (3) the motion may be pseudo-random to reduce standing-wave effects, and (4) the agitating device should be small to coincide with the small size of microarray devices and their use in both manual and robotic applications. In addition, the vibratory frequencies used may be well below the frequency of ultrasound, where sonication occurs. If ultrasound frequencies are used, impact damage to the bio-molecular reactants can occur, causing a loss of both epitope and paratope conformation.

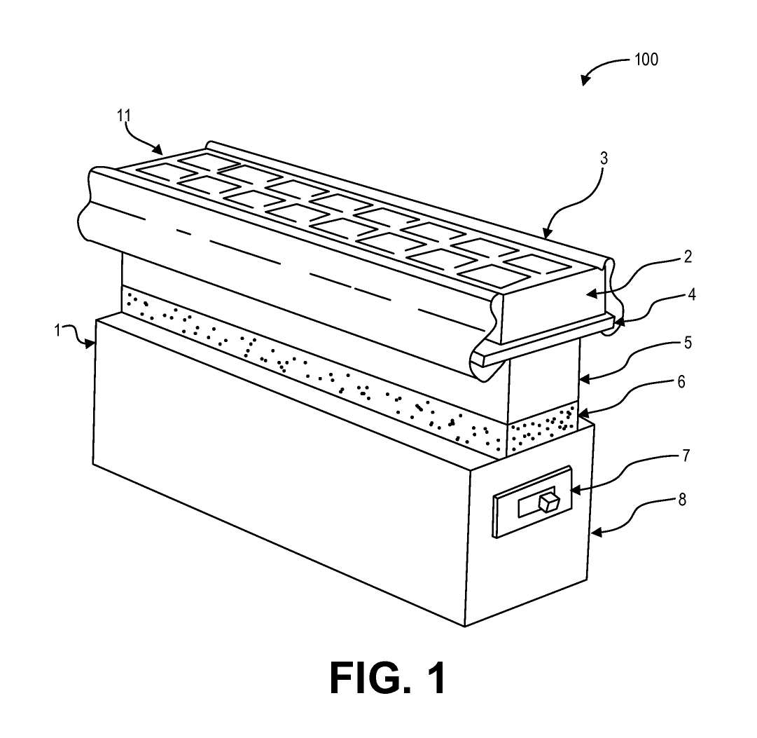

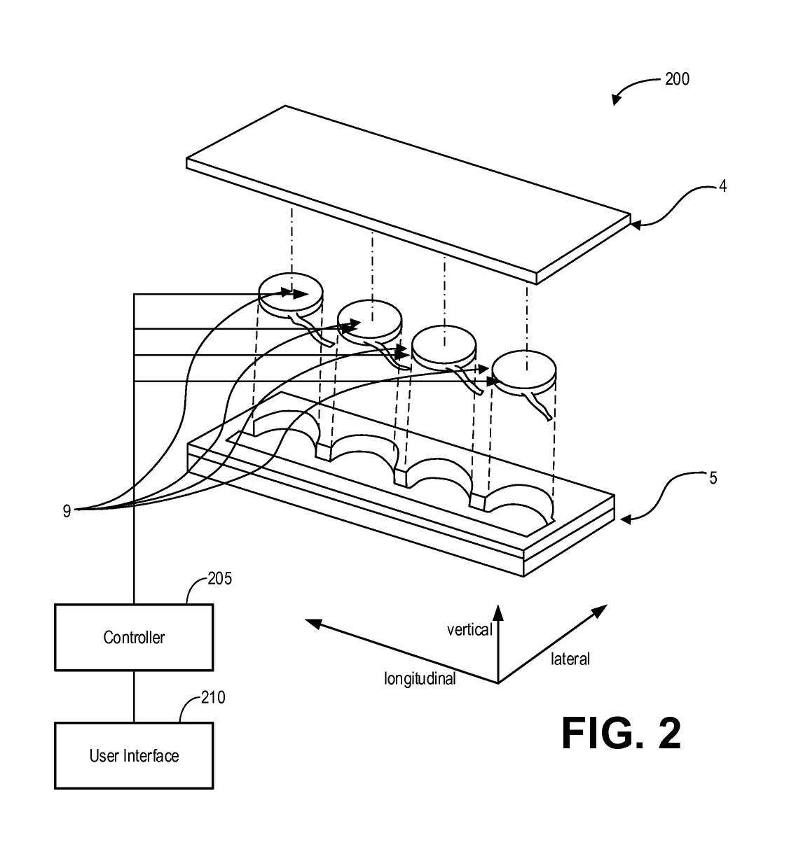

An agitation device 100 that takes at least some of the above factors into consideration is illustrated in FIGS. 1 and 2. High-speed agitation is produced by a plurality of relatively small vibration motors 9 attached to a motor platform 4. These motors 9 can be of the type used in cellular telephones, pagers, and the like, and may be selectively configured and/or controlled to produce semi-random motion of small amplitude. The vibration motors 9 may be directly coupled to a suspended platform 4 that is designed to hold the microarray reaction vessel 2 in firm contact with the platform through the use of metal clips 3. The platform consists of an upper plate 4 and a lower motor cage 5. The vibrational motors 9 produce agitation by coupling vibrational motion to the vessel 2 through sonic vibration at a randomized frequency that is commensurate with the physical size of the reaction chambers 11 in the vessel 2. An elastomeric material 6 is used to attach the motor platform 4 to a base 8, and forms a suspension mechanism to allow the platform 4 to vibrate efficiently, independent of the base 8. The base 8 is large enough to support the motor platform 4 and microarray vessel 2 and it can also contain electronics needed for driving the motors 9. In the present example, a manual switch 7 is provided to turn the vibration on and off as desired. Driving energy can be supplied by a battery (not shown) located in the base 8 or by external power (not shown) such as a DC power supply. In automated applications, a microcontroller 205 can be utilized to provide a vibration pattern whose amplitude, duty factor, rest periods, etc. can be tailored to the requirements of the particular assay. Note that the microcontroller 205 may comprise a processor and a non-transitory memory, and that the generation of pseudo-random voltage signals and the control of the vibration motors with said pseudo-random voltage signals may be implemented as instructions in the non-transitory memory of the microcontroller 205 that when executed cause the microcontroller to perform actions such as controlling the vibration motors.

Note that FIGS. 1-2 are approximately to scale, although other dimensions and relative proportions may be used, if desired. Further, the drawings illustrate relative positioning of components with respect to each other, for example showing components in face-sharing contact, directly contacting one another, etc. Alternatively, additional components may be added, or components removed, if desired.

The agitation device 100 can be smaller than conventional mixers; in principle it could have a footprint that is slightly larger than a microscope slide. Vertical height may be primarily determined by the size of the base 8 containing the driving electronics and battery, if a battery is used as the power source. This small footprint makes the mixer particularly suited for robotic applications where the mixer 100 may be integrated into the automated assay workspace.

The described example may be well suited for mixing applications where the vessel is small and overcomes the limitations of standing-wave artifacts in the microarray background. This is useful for both rectangular and cylindrical geometries and offers the advantage to effect mixing in the corners of the rectangular vessel and the center of the cylindrical vessel, where mixing dead zones are likely to occur.

The described examples may also be advantageous in microfluidic applications where small amounts of reactants are flowed into a miniature reaction chamber. By introducing semi-random vibratory motion, the reagents can be made to react more efficiently and washing can occur more thoroughly than if fluid flow alone is relied upon.

Efficiency of mixing in small vessels is important for portable test instruments if the assay sensitivity and specificity are expected to approach or be equivalent to more complex laboratory instruments. The described invention is advantageous in applications where diagnostic testing is performed in remote locations, such as infectious disease screening and testing in rural areas and developing countries. The invention can be made small enough and would consume low enough power that it could be employed in small, battery-operated field-deployable diagnostic instruments.

In this disclosure, one example application has been described in relation to microarrays and microfluidics. However, many of the advantages could also apply to other vessels such as miniature test tubes and sample tubes.

Thus, in one example, the described system may comprise a miniature reagent mixing or agitation device suitable for use with microarrays that are printed and assayed in a microscope slide-size format, optionally containing a plurality of individual reaction chambers combined together. The agitation device provides agitation by driving the aqueous reacting fluid through sonic vibration rather than wave motion and does not depend on the force of gravity to drive the mixing. This enables the mixing to be efficient by overcoming the surface tension of water even when the size of the reaction vessel is small. Additionally, pseudo-random vibration reduces or eliminates standing-waves that can lead to artifacts in the assay background or variations in assay signal across the array surface. Due to its small size, the device consumes a minimal amount of power and can be incorporated into robotic and field-deployable applications.

Through the use of a microcontroller (e.g., controller) 205, the vibration patterns can be programmed to meet the requirements of individual assay protocols. Due to the increased efficiency over orbital, oscillatory, and vortex mixers, microarray immunoassays in small vessels incorporating this invention can achieve sensitivity and specificity measures comparable to assays performed with more complex instrumentation. The invention provides pseudo-random sonic vibrational motion, critical for elimination of mixing dead zones and increased efficiency. In contrast to larger, more complex mixers known in the art, the present disclosure describes a device that is smaller, more efficient, requires less power, and is easily integrated into robotic, integrated, and portable instrumentation.

The system described may be designed with the capability to adjust the mixing parameters such as pseudo-random frequencies, voltages, and on/off intervals. This may facilitate adjustments in the efficiency or timeframe of the aqueous mixing function. In one example, these adjustments may be programmed via a self-contained user interface 210 such as a touch screen or control panel on the mixer.

Additionally or alternatively, the adjustments may be programmed in the controller 205 via a connection between the controller 205 and a computing device (e.g., a personal computer) with an accompanying software interface. The connection may comprise a USB, serial, wireless, or other suitable computer-to-controller interface. Programming instructions may then be sent from the personal computer to the controller 205, which would in turn execute the instructions to make the appropriate adjustments to the mixing parameters.

Thus the system further comprises a user interface 210 communicatively coupled to the controller 205, wherein the controller 205 includes instructions that when executed cause the controller 205 to adjust at least one control parameter responsive to input received from the user interface.

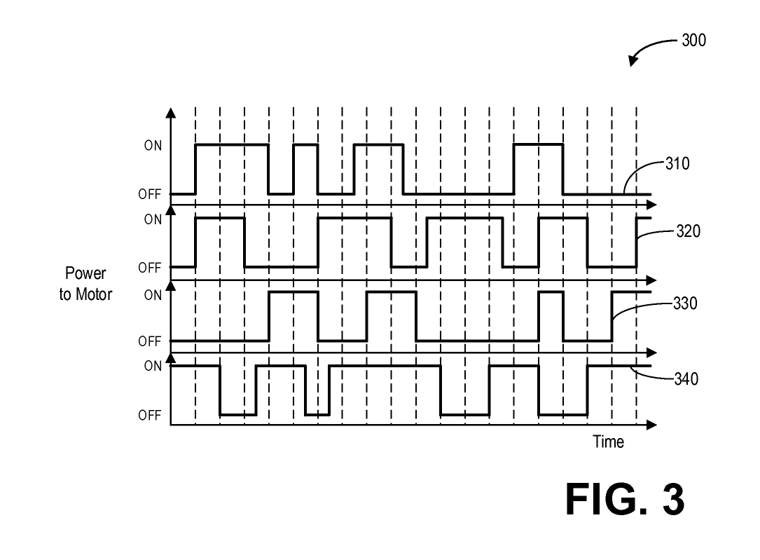

FIG. 3 shows a set of graphs 300 illustrating example pseudo-random motor commands generated by a controller and sent to four different motors, such as the controller 205 and the motors 9 shown in FIG. 2. Specifically, the graphs 300 include a plot 310 of the power provided to a first motor, a plot 320 of the power provided to a second motor, a plot 330 of the power provided to a third motor, and a plot 340 of the power provided to a fourth motor. In the example described herein above with regard to FIG. 2 wherein the mixer includes four vibration motors 9, each plot illustrates the power provided to a corresponding motor. The graphs 300 depict voltage (i.e., power supplied to each motor) on the vertical axis and time on the horizontal axis. Each of the motor commands may be provided to generate pseudo-random vibration in the mount. Further the combination of the commands may further randomize the vibration. The vibration may be controlled at different levels and frequency ranges by adjusting and/or combining various motors commands. In one example, the first motor refers to the motor on the far left of FIG. 2, the second motor refers to the motor to the immediate right of the first motor, and so on.

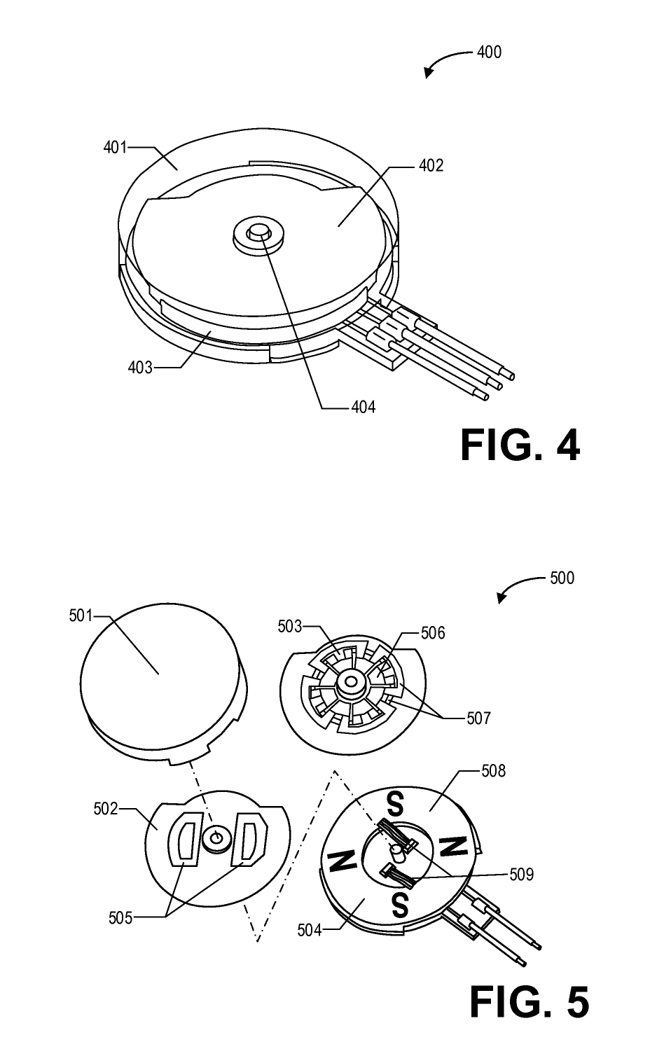

FIG. 4 shows an example coin-shaped vibration motor 400 according to an embodiment. As a non-limiting example, the motors 9 of the agitation device 100 described herein above with regard to FIGS. 1-2 may comprise a plurality of vibration motors 400. The vibration motor 400 may comprise a relatively small electrical motor that drives an unbalanced weight. In this example, a relatively flat eccentric weight 403 spins in a protective enclosure 401 of the vibration motor 400, which further comprises a rotor base 402 and shaft 404. The motor may be a direct current (DC) brush or brushless motors. The motor may be configured in various forms, such as coin (or flat) or cylinder (or bar-shaped).

As shown in FIG. 5, an exploded view of a brush coin-shaped vibration motor 500 is provided. The vibration motor 500 comprises an enclosure top 501, rotor 502 (view as mounted), rotor 503 (inverted view), enclosure bottom 504, coils 505, commutation points 506, alternating power supply circuits 507, ring magnet 508 (showing representative polar zones), and power supply brushes 509. The motors may be controlled by a controller in combination with drive circuitry, such as application specific integrated chips (ASIC) designed for this purpose.

As will be appreciated by one of ordinary skill in the art, the methods described herein may represent one or more of any number of processing strategies such as event-driven, interrupt-driven, multi-tasking, multi-threading, and the like that may be used in combination with one or more elements such as sensors, actuators, devices, etc. As such, various steps or functions described or illustrated may be performed in the sequence illustrated, in parallel, or in some cases omitted. Likewise, the order of processing is not necessarily required to achieve the objects, features, and advantages described herein, but is provided for ease of illustration and description. Although not explicitly illustrated, one of ordinary skill in the art will recognize that one or more of the illustrated steps or functions may be repeatedly performed depending on the particular strategy being used. Further, the described actions, operations, methods, and/or functions may graphically represent code to be programmed into non-transitory memory of the computer readable storage medium in the engine control system that, in combination with the disclosed structural elements such as sensors, actuators, and devices, may carry out one or more actions of the disclosed methods of operation.

The above operation, advantages and other advantages, and features of the present description are provided to introduce in a selection of concepts. There is no intention to identify key or essential features. Furthermore, the disclosed subject matter is not limited to implementations that solve any disadvantages noted above or in any part of this disclosure.

In one example, a system is provided that comprises a microarray having one or more vibration motors coupled thereto. The coupling can include a rigid connection. In combination with any of the preceding sentences of this paragraph, the coupling can include a fixed mechanical connection. In combination with any of the preceding sentences of this paragraph, the coupling can include a fixed mechanical connection to a mount, the motors mounted in the mount and the microarray fixedly removeably coupled to the mount. In combination with any of the preceding sentences of this paragraph, the system may further include a controller with instructions stored in memory to send command signals to one or more motors mounted in the mount. In combination with any of the preceding sentences of this paragraph, the motors may be referred to as coin-shaped vibration motors. In combination with any of the preceding sentences of this paragraph, the motors may be brushless and/or brushed motors. In combination with any of the preceding sentences of this paragraph, the controller may send different command signals to different motors in the mount. In combination with any of the preceding sentences of this paragraph, the different command signals may be sent simultaneously. In combination with any of the preceding sentences of this paragraph, the micro array may include a microarray reaction vessel in face sharing contact via its bottom surface with a suspended platform. In combination with any of the preceding sentences of this paragraph, the suspended platform may be positioned directly above a motor cage housing a plurality of coin-shaped vibration motors. In combination with any of the preceding sentences of this paragraph, the vibration motors may be mounted with a central rotational axis being vertically positioned normal with respect to a plane of the suspended platform surface. In combination with any of the preceding sentences of this paragraph, each of the motors may be positioned with its rotational axis in parallel with each other, and vertically below the microarray such that a top surface of fluid in the microarray is parallel with flat disk-shaped plates of the vibration motors. In combination with any of the preceding sentences of this paragraph, the controller may generated high-speed agitation via the vibration motors attached to the platform. In combination with any of the preceding sentences of this paragraph, an elastomeric material may be used to attach the motor platform to a base and form a suspension mechanism to allow the platform to vibrate efficiently, independent of the base.

In one embodiment, a system comprises a microarray having one or more vibration motors coupled thereto. In a first example of the system, the coupling includes a rigid connection. In a second example of the system optionally including the first example, the coupling includes a fixed mechanical connection. In a third example of the system optionally including one or more of the first and second examples, the coupling includes a fixed mechanical connection to a mount, the one or more vibration motors mounted in the mount and the microarray fixedly and removeably coupled to the mount. In a fourth example of the system optionally including one or more of the first through third examples, the system further comprises a controller with instructions stored in non-transitory memory that when executed cause the controller to send command signals to the one or more vibration motors. In a fifth example of the system optionally including one or more of the first through fourth examples, the controller sends different command signals to different motors. In a sixth example of the system optionally including one or more of the first through fifth examples, the different command signals are sent simultaneously. In a seventh example of the system optionally including one or more of the first through sixth examples, the one or more vibration motors comprise coin-shaped vibration motors. In an eighth example of the system optionally including one or more of the first through seventh examples, the one or more vibration motors comprise brushless motors. In a ninth example of the system optionally including one or more of the first through eighth examples, the one or more vibration motors comprise brushed motors. In a tenth example of the system optionally including one or more of the first through ninth examples, the microarray includes a microarray reaction vessel in face-sharing contact via its bottom surface with a suspended platform. In an eleventh example of the system optionally including one or more of the first through tenth examples, the suspended platform is positioned directly above a motor cage housing the one or more vibration motors. In a twelfth example of the system optionally including one or more of the first through eleventh examples, the one or more vibration motors are mounted with a central rotational axis being vertically positioned normal with respect to a plane of the suspended platform. In a thirteenth example of the system optionally including one or more of the first through twelfth examples, each of the motors are positioned with its rotational axis in parallel with each other, and vertically below the microarray such that a top surface of fluid in the microarray is parallel with flat disk-shaped plates of the vibration motors. In a fourteenth example of the system optionally including one or more of the first through thirteenth examples, the system further comprises a controller with instructions in non-transitory memory that cause the controller to generate high-speed agitation of the microarray via the one or more vibration motors attached to the suspended platform.

In another embodiment, a method comprises generating, via a microcontroller, a plurality of pseudo-random voltage signals, and controlling, via the microcontroller, a plurality of vibration motors based on the plurality of pseudo-random voltage signals, wherein each of the pseudo-random voltage signals is separately provided to a different motor of the plurality of motors, and wherein the plurality of vibration motors are coupled to a microarray. In a first example of the method, the method further comprises generating the plurality of pseudo-random voltage signals and controlling the plurality of vibration motors responsive to a switch switching from an off state to an on state. In a second example of the method optionally including the first example, the method further comprises terminating control of the plurality of vibration motors responsive to the switch switching from the on state to the off state.

In yet another embodiment, an apparatus comprises a microarray including a microarray reaction vessel in face-sharing contact via its bottom surface with a suspended platform, the suspended platform positioned directly above a motor cage housing a plurality of vibration motors, each of the plurality of vibration motors positioned with its rotational axis in parallel with each other, and vertically below the microarray such that a top surface of fluid in the microarray is parallel with flat disk-shaped plates of the vibration motors. In an example of the apparatus, the apparatus further comprises at least one metal clip, wherein the at least one metal clip couples the suspended platform to the microarray reaction vessel.

1. A system, comprising:
a microarray having one or more vibration motors coupled thereto.

2. The system of claim 1, wherein the coupling includes a rigid connection.

3. The system of claim 1, wherein the coupling includes a fixed mechanical connection.

4. The system of claim 1, wherein the coupling includes a fixed mechanical connection to a mount, the one or more vibration motors mounted in the mount and the microarray fixedly and removeably coupled to the mount.

5. The system of claim 1, further comprising a controller with instructions stored in non-transitory memory that when executed cause the controller to send command signals to the one or more vibration motors.

6. The system of claim 5, wherein the controller sends different command signals to different motors.

7. The system of claim 6, wherein the different command signals are sent simultaneously.

8. The system of claim 1, wherein the one or more vibration motors comprise coin-shaped vibration motors.

9. The system of claim 1, wherein the one or more vibration motors comprise brushless motors.

10. The system of claim 1, wherein the one or more vibration motors comprise brushed motors.

11. The system of claim 1, wherein the microarray includes a microarray reaction vessel in face-sharing contact via its bottom surface with a suspended platform.

12. The system of claim 11, wherein the suspended platform is positioned directly above a motor cage housing the one or more vibration motors.

13. The system of claim 11, wherein the one or more vibration motors are mounted with a central rotational axis being vertically positioned normal with respect to a plane of the suspended platform.

14. The system of claim 11, wherein each of the motors are positioned with its rotational axis in parallel with each other, and vertically below the microarray such that a top surface of fluid in the microarray is parallel with flat disk-shaped plates of the vibration motors.

15. The system of claim 11, further comprising a controller with instructions in non-transitory memory that when executed cause the controller to generate high-speed agitation of the microarray via the one or more vibration motors attached to the suspended platform.

16. The system of claim 15, further comprising a user interface communicatively coupled to the controller, wherein the controller further includes instructions that when executed cause the controller to adjust at least one control parameter responsive to input received from the user interface.

17. A method, comprising:
generating, via a microcontroller, a plurality of pseudo-random voltage signals; and
controlling, via the microcontroller, a plurality of vibration motors based on the plurality of pseudo-random voltage signals, wherein each of the pseudo-random voltage signals is separately provided to a different motor of the plurality of motors, and wherein the plurality of vibration motors are coupled to a microarray.

18. The method of claim 17, further comprising generating the plurality of pseudo-random voltage signals and controlling the plurality of vibration motors responsive to a switch switching from an off state to an on state.

19. An apparatus, comprising:
a microarray including a microarray reaction vessel in face-sharing contact via its bottom surface with a suspended platform, the suspended platform positioned directly above a motor cage housing a plurality of vibration motors, each of the plurality of vibration motors positioned with its rotational axis in parallel with each other, and vertically below the microarray such that a top surface of fluid in the microarray is parallel with flat disk-shaped plates of the vibration motors.

20. The apparatus of claim 19, further comprising at least one metal clip, wherein the at least one metal clip couples the suspended platform to the microarray reaction vessel.
